(19) United States
(12) Patent Application Publication
(10) Pub. No.: US 2010/0106836 A1
(43) Pub. Date: Apr. 29, 2010

(54) NETWORKED CONTROL SYSTEM AND DEVICE FOR A NETWORKED CONTROL SYSTEM

(75) Inventors: Oliver Schreyer, Herzogenrath (DE); Bozena Erdmann, Aachen (DE); Armand Michel Marie Lelkens, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,883

(22) PCT Filed: Feb. 7, 2008
(86) PCT No.: PCT/IB08/50446

§ 371 Date: Aug. 5, 2009

(30) Foreign Application Priority Data
Feb. 12, 2007 (EP) 07102127.3

(51) Int. Cl. G06F 15/173; G06F 15/16

(52) U.S. Cl. 709/226; 709/245; 709/223

(57) ABSTRACT

The invention relates to a networked control system including comprising a resource limited device (102) and an assigned proxy device (104). The resource limited device (102) comprises a device logic (122) for providing a change notification message to the assigned proxy device (104) on a change of a device state of the resource limited device, wherein each device state of the resource limited device (102) is defined by a corresponding state variable and wherein the change notification message comprises a state variable corresponding to an actual device state of there source limited device (102). The assigned proxy device (104) comprises means (142) for receiving a change notification message from an assigned resource limited device (102), wherein the change notification message comprises a state variable which defines an actual device state of the resource limited device and means (144) for distributing a state variable change notification, comprising the state variable which defines the actual device state of the resource limited device, within the networked control system according to requirements of a control application (162) of the networked control system.

The invention relates to a networked control system and devices for a networked control system and in particular to a networked control system including a resource limited device.

Networked control systems are a ubiquitous trend in commercial, industrial and institutional business markets and also in consumer markets. Examples for networked control systems are building automation systems, e.g. for lighting, heating and ventilation or safety. A networked control system may consist of devices like light ballasts, switches, daylight or occupancy sensors, actuators or meters. The devices are preferably connected wirelessly i.e. via RF (radio frequency) modules.

The functionality of a networked control system is typically defined by device logic consisting of states and functions of the devices and by control applications that interact with the device logic. The states and functions of the devices may be vendor-defined and are often standardized. The control applications may be vendor-defined and are sometimes user-defined.

Control applications in such systems usually interact with multiple devices, such that some of the interactions between control logic and device logic have to rely on the communication of information between the devices. The control applications usually interact by issuing commands to different devices or by taking information of or from multiple devices as input. In general, considering a device and a piece of control application software assigned to it, some of the interactions between control and device logic are local to the device, while others have to rely on the communication of information between devices via communication protocols or other mechanisms known in the art.

There may be devices with very limited resources, like batteryless radio frequency switches, which may not be capable of fulfilling the processing and communication requirements of the control applications.

Such batteryless RF devices are described on http://www.enocean.com. http://www.enocean.com/php/upload/pdf/DB_ENG2.pdf describes a radio transmitter module which enables the implementation of wireless remote controls without batteries. Power is provided by a built-in electro-dynamic power generator. Key applications are wall-mounted flat rocker switches. When an energy bow is pushed down, electrical energy is created and a RF telegram is transmitted including a 32-bit module ID. Releasing the energy bow generates different telegram data, so every telegram contains the information that the bow was pressed or released.

It is an object of the present invention to provide an improved resource limited device, an improved proxy device, an improved device for a networked control system, an improved networked control system, an improved method for establishing a networked control system and an improved method for transmitting a change notification message from a resource limited device to a proxy device.

A basic idea of the invention is to integrate devices with very limited resources into a networked control system by assigning one or a plurality of proxy devices to each device state variable of the resource limited device. A proxy device may hold a master instance of a device state variable, though the state variable does not reflect a state of the proxy device. Further the proxy device may hold related support logic for the device state variable. The proxy device is thereby a point of convergence and a reference for all subscribed devices. The proxy device is expected to be more powerful than the resource limited device, especially with respect to energy resources.

This allows reducing the logic of the resource limited device to the capability of providing the values of the related device state variables to the proxy device. This provision may be done in form of device state change notification information transferred to the related proxy device after the device state of the resource limited device has changed.

According to an embodiment, the invention provides a resource limited device for a networked control system including a plurality of devices, comprising:
a device logic for providing a change notification message to an assigned proxy device on a change of a device state of the resource limited device, wherein each device state of the resource limited device is defined by a corresponding state variable and wherein the change notification message comprises a state variable corresponding to an actual state of the resource limited device.

According to an embodiment, the invention further provides a proxy device for a networked control system including a plurality of devices, comprising:
means for receiving a change notification message from an assigned resource limited device, wherein the change notification message comprises a state variable which defines an actual device state of the resource limited device;
means for distributing a state variable change notification being based on the change notification message within the networked control system according to requirements of a control application of the networked control system.

According to an embodiment, the invention further provides a device for a networked control system including a resource limited device and a proxy device according to an embodiment of the invention, comprising:
means for receiving a change notification message and an acknowledgement broadcast;
means for storing the change notification message; and
means for resending the change notification message in case the device does not received the acknowledgement broadcast within a predefined time interval.

According to an embodiment, the invention further provides a networked control system including a plurality of devices, comprising:
a resource limited device according to an embodiment of the invention; and
an assigned proxy device according to an embodiment of the invention.

According to an embodiment, the invention further provides a method for establishing a networked control system including a plurality of devices, comprising:
providing a resource limited device according to an embodiment of the invention;
providing a proxy device according to an embodiment of the invention; and
assigning the proxy device to the resource limited device.

According to an embodiment, the invention further provides a method for transmitting a change notification message from a resource limited device to a proxy device via a device according to an embodiment of the invention, comprising:
broadcasting the notification message by the resource limited device;
receiving the change notification message by the at least one device;
storing the change notification message by the at least one device; and
resending the change notification message by the at least one device in case the device does not receive the acknowledgement broadcast from the proxy device within a predefined time interval.

The term “networked control system” may mean a control system in which the communication of control-related information is done transparently to a control application, and in which control logic can be assigned to any device of the target networked control system. Thus, runtime control code can be flexibly distributed, e.g. by taking device resources into account, and devices may simply host a support logic while the control logic is running elsewhere. In a runtime networked control system, the control applications are realized by executing a control logic code or runtime code (Executors) on the assigned devices deploying automatically generated support logic for the communication of information between devices where needed.

In such a networked control system, device logic, i.e. possible control parameters and functions, provided out-of-the-box by the devices, is exclusively represented by state variables representing the attributes of the hardware and software state of a device, e.g. the dimming level of a lamp. Control logic programs are defined on all device state variables of devices belonging to the networked control system and further on user-defined system state variables. In a compilation step, control logic programs are translated to Executors each of which is assigned to an executing device. In addition, support logic realizing the communication of information necessary for running the Executors is instantiated. The main task of the support logic is to enable local execution of the runtime code by providing values of all involved state variables.

In such a networked control system, any state variable has a master device, i.e. a device at which the master instance of the state variable is held. If a state variable is input for or output of an Executor hosted by a device other than the master device, support logic ensures that state variable values are transferred appropriately, e.g. such that the Executor runs on actual values of the input state variables. For example, a local copy of all input state variables is held at the device hosting the Executor and support logic at the master device or devices transfer changes of the master instance or instances, by sending change notifications, to the device hosting the Executor. In general, for all master instances at a device, support logic sends change notifications to all devices holding copies of those state variables, i.e. to all devices subscribed to those state variables.

Such a networked control system allows a flexible distribution of control logic in the target system but there may be devices with very limited resources, e.g. batteryless RF switches that are even not capable of fulfilling the processing and communication requirements of the support logic. The capabilities of a resource limited device may be reduced up to a transmission of single messages.

According to an embodiment, the resource limited device may be configured to provide a uni-directional communication link for transmitting the change notification message to the assigned proxy device. This allows reducing the logic required for operating the resource limited device.

The resource limited device may comprise an identification address and the device logic may be configured to include the identification address into the change notification message. This allows the proxy device or other devices to assign a received change notification message to the resource limited device.

Further, the resource limited device may be configured to broadcast the change notification message. By broadcasting the change notification message to all devices it is not necessary for the resource limited device to hold any information about the control system or the assigned proxy device. Thus, the need for configuration of the resource limited device is avoided.

According to an embodiment the resource limited device may comprise a small battery, a solar cell, passive coupling technology means or an energy harvesting feature based on temperature differences, vibration, pressure, light or motion which provides energy necessary for providing the change notification message. This allows supplying the resource limited device with the necessary energy for operating.

According to an embodiment, the resource limited device may comprise passive coupling technology means which provides energy when activated by the proxy device. The device logic may be configured to transmit the provided change notification message when the passive coupling technology means is activated by the proxy device. This allows reading the change notification message from the resource limited device without the need of an internal energy resource.

According to a further embodiment the resource limited device may be configured to receive a change request from the assigned proxy device which triggers a change of an actual device state of the resource limited device. This allows changing a configuration or a state of the resource limited device controlled by the networked control system.

Further, the resource limited device may be configured to enter a reception mode which allows receiving the change request and may comprise synchronisation means which ensure that the proxy device transmits the change request while the resource limited device is in the reception mode. This allows reducing the energy consumption of the resource limited device as a time the resource limited device is capable of receiving the change request can be limited.

According to an embodiment, the resource limited device may exclusively comprise volatile memory means. This allows simplifying the design of the resource limited device.

According to a further embodiment the resource limited device may comprise storage for storing an address of the assigned proxy device. The device logic may be configured to include the address into the change notification message. This allows a direct transmission of the change notification message to the proxy device and allows an evaluation of the change notification message by other devices than the proxy device. Such other devices may forward the change notification message to the proxy device in case the proxy device has not received the change notification message.

According to an embodiment, the resource limited device may be a switch or a sensor.

According to an embodiment of the proxy device, the proxy device may comprises a storage for storing values of state variables belonging to the resource limited device and the proxy device may be configured to replace a stored state variable value by a corresponding actual state variable value received with the change notification message. This allows providing state variables to the control application without having to communicate with the resource limited device. Further, the proxy device may store state variables being required by the control application which cannot be stored by the resource limited device due to a lack of memory.

The proxy device may comprise passive coupling technology means for powering the resource limited device in order to retrieve the change notification message. This allows a more compact design of the resource limited device and reduces the maintenance effort for the resource limited device.

Further, the assigned proxy device may be configured to transmit an acknowledgement broadcast after having received the change notification message. The acknowledgment broadcast allows an intelligent broadcast scheme to increase the success rate of a transmission of the change notification message transmitted from the resource limited device. The scheme may significantly increase the likelihood that the change notification message is finally received by the proxy device.

According to an embodiment of the device, the means for storing may be configured to stop storing the change notification message after receiving the acknowledgement broadcast. Thus, the means for storing can be cleared from data which no longer has to be stored.

Further, a length of the predefined time interval may device specific. This prevents a plurality of devices to resend the change notification message simultaneously.

According to an embodiment of the networked control system, the networked control system may comprise at least one device according to an embodiment of the invention. This allows establishing the intelligent broadcast scheme.

According to an embodiment, the assigned proxy device may be configured to transmit the state variable change notification message to a selected device of the plurality of devices which executes the control application. The control application may be configured to process the state variable of the change notification message. This allows running the control application on any device of the networked control system.

According to an embodiment of the networked control system, the networked control system may comprise means for detecting the resource limited device and for assigning the proxy device to the resource limited device. This allows an automatic recognition and integration of the resource limited device by the networked control system.

According to an embodiment the networked control system may comprise a plurality of proxy devices, wherein the means for detecting is configured to assign a most suitable proxy device to the resource limited device, e.g. based on proximity measurements.

The means for detecting may further be configured to instantiate control logic and support logic at the proxy device. The control logic and support logic may be usable for integrating the resource limited device into the networked control system. This allows integrating the resource limited device into the networked control system via the proxy device.

The means for detecting may be configured to integrate the resource limited device into the controlled network device without performing any configuration steps on the resource limited device. This allows a fast integration process. Further, there may be no configurable logic necessary at the resource limited device.

According to a further embodiment, the networked control system may comprise a number of proxy devices being assigned to the resource limited device, wherein each of the number of proxy devices is configured to receive a change notification message comprising a predefined state variable of the resource limited device. This allows assigning each state variable of the resource limited device to a separate proxy device.

According to a further embodiment of the invention, a computer program may be enabled to carry out the methods according to embodiments of the invention.

Further, a record carrier may store a computer program according to an embodiment of the invention.

The invention will be described in more detail hereinafter with reference to exemplary embodiments. However, the invention is not limited to these exemplary embodiments.

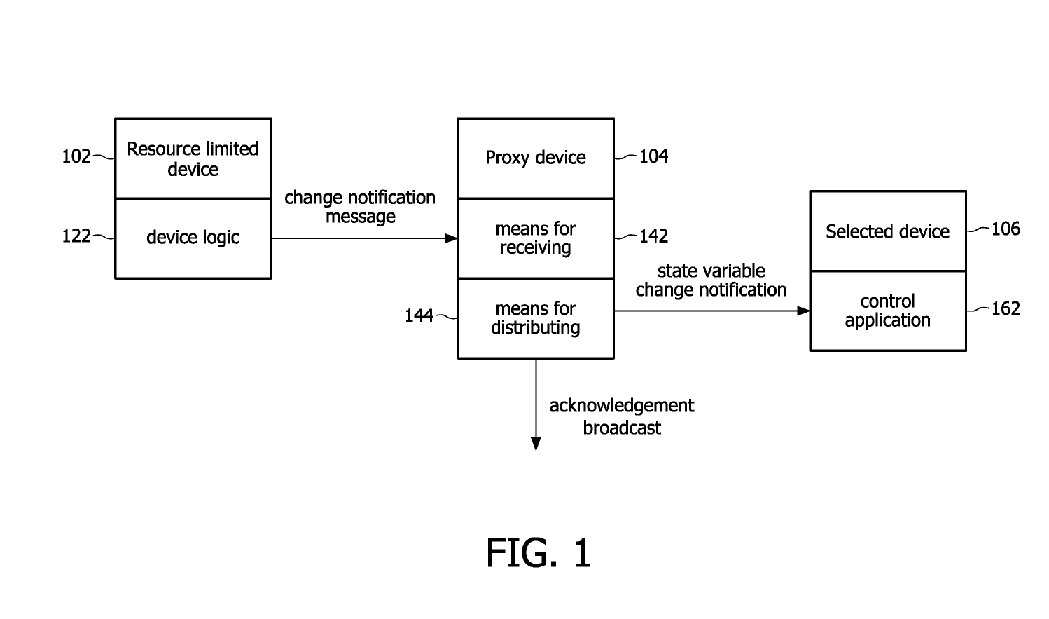

FIG. 1 shows a networked control system according to an embodiment of the invention; and

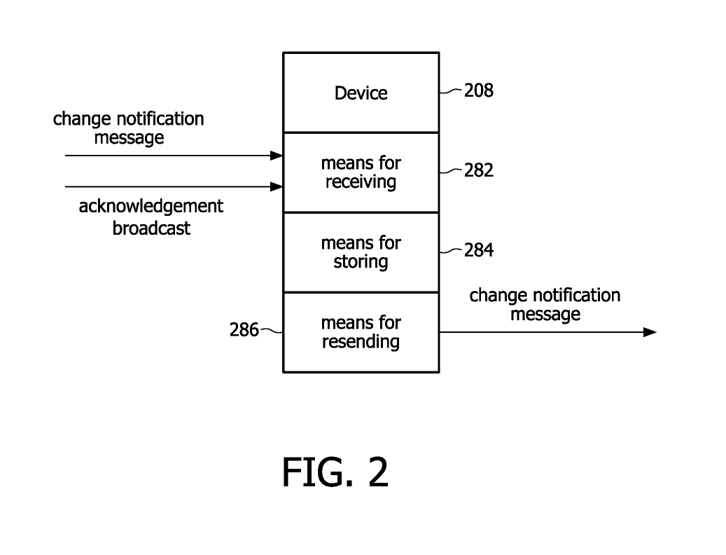

FIG. 2 shows a device for a networked control system according to an embodiment of the invention.

In the following, functional similar or identical elements may have the same reference numerals.

FIG. 1 shows a networked control system comprising a resource limited device 102, a proxy device 104 and a selected device 106 according to an embodiment of the present invention. The device 102, 104, 106 are exemplary chosen. The networked control system may comprise a plurality of further resource limited devices, proxy devices and selected devices and a plurality of other devices. The devices 102, 104, 106 may be connected by a communication system, for example a wireless communication system. The networked control system may comprise means (not shown in the Figures) for detecting and assigning the resource limited device (102).

The resource limited device 102 is configured to provide change notification message to the proxy device 104. The proxy device 104 is configured to receive the change notification message and transmit a state variable change notification to the selected device 106. Further, the proxy device 104 may be configured to transmit an acknowledge broadcast after having received the change notification message.

The resource limited device 102 comprises device logic 122 for providing the change notification message to the assigned proxy device 104. The device logic 122 is configured to provide the change notification triggered by a change of a device state of the resource limited device 102. Each device state of the resource limited device 102 may be defined by a corresponding state variable. The provided change notification message comprises a state variable which describes an actual device state of the resource limited device 102. The resource limited device 102 may broadcast the change notification message into the networked control system or transmit the change notification message directly the proxy device 104.

The proxy device 104 comprises means 142 for receiving and means 144 for distributing. The means 142 for receiving may be configured to receive the change notification message. The means 144 for distributing may be configured to transmit a state variable change notification to the selected device 106. The means 144 for distributing may be configured to evaluate or process the received change notification message and to provide the state variable change notification to be transmitted. The state variable change notification comprises the state variable received with the change notification message. The state variable change notification may be identical with the change notification message. The means 144 for distributing may comprise support logic assigned to the state variable belonging to the resource limited device 102.

According to an embodiment the means 144 for distributing is configured to further transmit an acknowledgment broadcast after having received the change notification message. The acknowledgment broadcast may be received by any device of the networked control system.

The selected device 106 may host an environment for executing a control application 162. The control application 162 may control runtime behaviour of the networked control system or of individual devices of the networked control system. For operation, the control application 162 may require the state variables from the resource limited device which are provided to the selected device 106 via the proxy device 104.

A transfer of device state change notification information may be performed in different ways dependent on a technology used by the resource limited device 102. According to an embodiment the resource limited device 102 is capable to perform an active communication. Therefore, the resource limited device 102 may be powered by a very small battery, by a solar cell or by energy harvesting features. The energy harvesting features may be based on temperature differences, vibration, pressure, light or motion or a combination thereof. According to another embodiment, the resource limited device 102 may be passive, while the proxy device 104 is actively, e.g. on schedule retrieving the current state information by way of the change notification message from the limited resource device. In this case the resource limited device may be batteryless. The proxy device 104 may retrieve the current state information by powering the resource limited device by using passive coupling technology, e.g. RF-ID.

On receipt of a device state change notification from the resource limited device 102, the proxy device 104 may change locally a value of a master instance of the state variable and start related support logic. This may include sending out change notifications to subscribed devices.

As an example, the resource limited device 102 may be a batteryless switch being equipped with an electro-dynamic energy transducer. The transducer allows the switch to be inactive most of the time, awake only when a button of the switch is pushed by a user. By pushing the button electrical energy is created which is usable to send the change notification message. Afterwards the switch returns to inactivity again. After receiving the device state change notification, the proxy device 104 informs all devices interested in the related state of the batteryless switch, by sending state variable change notifications to them. The selected devices which may be interested in the related state of the switch may be lamps being controlled by the switch.

According to an embodiment the resource limited device 102 is of a controller type or a sensor type whose device state is never changed by control logic but only by real world events as the user pressing the button. Such a resource limited device 102 only provides device state information as input for control logic and, thus, the information exchange between the resource limited device 102 and the proxy device 104 is uni-directional. The change notification message is just providing the limited resource device state change information to the proxy device 104.

Alternatively, also communication in the other direction, from the networked control system or the proxy device 104 to the resource limited device 102, may need to be supported. Such a communication to the resource limited device 102 may be required, if the device state of the resource limited device 102 can also be changed by the control logic of the networked control system. In this case the control logic may change the master instance at the proxy device 104. An example of such a communication is calibration information for a batteryless light sensor.

For externally changing the device state of the resource limited device 102, the proxy device 104 may inform the resource limited device 102 with a device state change request to change the actual device state at the resource limited device 102. To avoid that the resource limited device 102 has to be in reception mode all time, which would consume power, the resource limited device 102 may enter this mode on schedule, for example in a regular frequency. The schedule may be either synchronized with the proxy device 104, which may exactly then send the most recent device state change request it received from the control system, or the resource limited device 102 may send one message stating that the resource limited device 102 has entered reception mode and the proxy immediately responds with the most recent device state change request or an indication that there was none. Thus, the time the resource limited device 102 has to stay in reception mode is minimized.

Not all changes of a proxied master instance of a resource limited device 102 state variable have automatically to be transferred to the resource limited device 102. The proxy device 104 may be configured such that the support logic at the proxy device 104 handles the change.

There may be one proxy device 104 assigned to each resource limited device 102. According to an alternative embodiment there is one proxy device 104 assigned to each state variable of a resource limited device 102. A selection of proxy devices per device state variable of a resource limited device 102 may be performed manually by the user. In a preferred embodiment, the selection it is performed automatically by a compiler assigning a runtime code to devices and instantiating the support logic. To support an automatic selection decision, devices may comprise a property “should be proxied”, i.e. a proxy should be defined and “can be proxy”, i.e. this device can be used as proxy device 104. The property may be manufacturer defined. An actual choice of the proxy device 104 further may take additional aspects into account, e.g. a network topology. For example a proxy device 104 in proximity to the resource limited (proxied) device may be chosen.

The proxy devices may be set up as normal devices. Control logic and support logic, including the support logic related to the resource limited device 102 (proxied device) is downloaded to each proxy device 104. In a preferred embodiment, resource limited devices do not need to be set up, because their identity and function is known in the system and the logic compiler and they are passive or use broadcast mechanisms to provide their state information. If the resource limited device 102 sends its device state change notifications as a broadcast message, all devices in the networked control system may receive the message, but only the proxy devices evaluate those change notifications related to master instances they hold. In this case the resource limited device 102 may not need any non-volatile memory at all.

In another embodiment, resource limited devices may store per device state variable an address of the assigned proxy device 104. Preferably, all device state variables are assigned to the same proxy device 104, such that the resource limited device 102 has to store only one address. If a resource limited device 102 needs to be set up, special steps, possibly including user interaction, may be needed.

In the networked control system according to an embodiment of the invention, a single one or a number of proxy devices may be assigned to each device state variable of the resource limited device 102. A proxy device 104 holds all relevant information, in particular the device state variable master instances, and the related support logic to act on behalf of the resource limited device 102. The logic of a resource limited device 102 may then be reduced to providing device state change notification information to the related proxy device 104 after the device state has changed. In a preferred embodiment the device state change notification message is sent as broadcast in order to avoid pre-configuration of the resource limited device 102. The proxy device 104 may then be pre-configured with the address and further information of the resource limited device 102 to act on receiving the broadcast, while other devices drop it. For several reasons, in particular in the case of wireless control networks, the proxy device 104 may not receive the broadcast. However, due to the resource limitations this message may not be acknowledged nor re-transmitted.

In order to improve the success rate of a transmission of the change notification message to the proxy device 104, the change notification message may be received by other devices of the networked control system.

FIG. 2 shows a device 208 according to an embodiment of the invention, which is capable of receiving the change notification message, too. The device 208 comprises means 282 for receiving, means 284 for storing and means 286 for resending. The means 282 for receiving are configured to receive the change notification message from the resource limited device and to provide the change notification message to the means 284 for storing. The means 284 for storing are configured to store the change notification message. The means 286 for resending are configured to read the change notification message from the means 284 for storing and to transmit the change notification message. The means 286 for resending are configured to resend the change notification message triggered by a predefined event. The predefined event may be an indication that the proxy device has not received the change notification message.

The proxy device may be configured to broadcast an acknowledgement message after having received the change notification message. The means 282 for receiving may be configured to receive the acknowledgement broadcast which indicates that the proxy device has received the change notification message. After having received the acknowledgement broadcast, there is no need for the device 208 to resend the change notification message or to store the change notification message any longer.

According to an embodiment the networked control system performs an intelligent evaluation of the change notification message to increase the success rate of transmitting the change notification message, even if the proxy device does not receive it.

According to an embodiment, the intelligent evaluation requires the resource limited device to send the change notification message as a broadcast message containing the address of resource limited device and the new value of the state variable.

Each device of the plurality of devices of the networked control system which receives the change notification message stores the change notification message for a pre-defined amount of time, e.g. 500 ms.

If the proxy device receives the change notification message, it will recognize from the source address, which may contain the address of the resource limited device, and its own pre-configuration that it has to act on the change notification message. Before performing the related control logic, the proxy device sends a device state change acknowledgement broadcast containing the address of the resource limited device and the transferred state variable value.

All devices receiving the acknowledgement broadcast drop the information they hold about the related change notification message.

If the proxy device does not receive the change notification message, it will not send the acknowledgement broadcast.

When at a device storing the change notification message a timer, of e.g. 500 ms, expires without receipt of the acknowledgement broadcast, this device will resend the original change notification message. Resending the change notification message has the same consequences as the transmission of the original change notification message, except that the devices having already received a previous transmission of the change notification message may simply reset their related timer.

In a preferred embodiment, before re-transmitting the change notification message the device may wait a device-specific amount of time, e.g. derived from a device MAC address to avoid that all devices storing this information re-transmit the change notification message at the same time.

In a further preferred embodiment, the re-transmission of the change notification message is limited to a pre-configured amount of times, e.g. 3 times. Therefore the devices 208 may maintain a counter which is evaluated in a way that the stored change notification message is dropped after the related number of transmissions.

In case of dropping information about the change notification message without receiving the related acknowledgement broadcast, the device dropping the change notification message may provide related information to a system maintenance function of the networked control system for reaction or logging.

Applications according to the present invention include an integration of resource-limited devices, like batteryless switches, batteryless sensors or devices without non-volatile memory in control systems such as complex lighting control systems, building automation systems, home control systems, atmosphere lighting systems and all other control and automation environments, including industrial, retail, institutional and residential.

At least some of the functionality of embodiments of the invention may be performed by hard- or software. In case of an implementation in software, a single or multiple standard microprocessors or microcontrollers may be used to process a single or multiple algorithms implementing embodiments of the invention.

It should be noted that the word “comprise” does not exclude other elements or steps, and that the word “a” or “an” does not exclude a plurality. Furthermore, any reference signs in the claims shall not be construed as limiting the scope of the invention.

Summarized, embodiments of the invention describe:

A networked control system in which
resource-limited devices are integrated by assigning proxy devices to them in that for each device state attribute one proxy device is assigned;
resource-limited devices interact with the control system only by providing change notification information to the related of proxy device which hosts the logic to evaluate and distribute this information in the control system according to the needs of the control applications.

The networked control system, in which selection of proxy devices is done automatically.

The networked control system, in which a compiler function gets the information about the resource-limited devices in the system, automatically selects the proxy devices, instantiates control and support logic, after which the control system is fully functional, i.e. no configuration step at the resource-limited devices is needed.

A resource-limited device prepared for integration into the networked control system, in that it can provide change notification information to an assigned proxy device.

The resource-limited device according that provides change notification information via broadcast.

The resource-limited device according that has no memory.

The resource-limited device that does not need to be configured.

The resource-limited device that is a batteryless switch.

The resource-limited device that is a batteryless sensor.

The resource-limited device that is passive and provides change notification information when being powered by the proxy device.

A networked control system in which
resource-limited devices are integrated by assigning proxy devices;
resource-limited devices interact with the control system only by providing change notification information to the related proxy device which hosts the logic to evaluate and distribute this information in the control system according to the needs of the control applications;
the change notification information is provided by a broadcast message from the resource-limited device;
all devices receiving this broadcast store it for a pre-defined amount of time;
the proxy device broadcasts an acknowledgement after receiving a change notification message;
all devices drop stored information about change notification after receiving a related acknowledgment;
a device storing change notification information as described above that does not receive an acknowledgement re-transmits the change notification information via broadcast

A device in a networked control system that
is assigned as proxy device to a resource-limited device;
on receipt of change notification information from the assigned resource-limited device reacts with an acknowledgment broadcast.

A further device in a networked control system, that
stores broadcasted change notification information from resource-limited devices;
resends the change notification information if no related acknowledgment broadcast is received.

The further device in a networked control system, that before resending the change notification information waits a device-specific amount of time.

1. A resource limited device for a networked control system including a plurality of devices, comprising:
a device logic for providing a change notification message to an assigned proxy device on a change of a device state of the resource limited device, wherein each device state of the resource limited device is defined by a corresponding state variable and wherein the change notification message comprises a state variable corresponding to an actual device state of the resource limited device.

2. The resource limited device according to claim 1, being configured to provide a uni-directional communication link for transmitting the change notification message to the assigned proxy device.

3. The resource limited device according to claim 1, comprising an identification address, wherein the device logic is configured to include the identification address into the change notification message.

4-5. (canceled)

6. The resource limited device according to claim 1, comprising means for providing energy when activated by the proxy device and wherein the device logic is configured to transmit the provided change notification message when the means is activated by the proxy device.

7. The resource limited device according to claim 1, being configured to receive a change request from the assigned proxy device which triggers a change of an actual device state of the resource limited device.

8. The resource limited device according to claim 7, being configured to enter a reception mode for enabling receiving the change request and further comprising synchronisation means for enabling the proxy device to transmit the change request while the resource limited device is in the reception mode.

9. The resource limited device according to claim 1, comprising volatile memory means.

10. The resource limited device according to claim 1, wherein the resource limited device comprises a storage for storing an address of the assigned proxy device and wherein the device logic is configured to include the address into the change notification message.

11. The resource limited device according to claim 1, wherein the resource limited device is a switch or a sensor.

12. A proxy device for a networked control system including a plurality of devices, comprising:
means for receiving a change notification message from an assigned resource limited device, wherein the change notification message comprises a state variable which defines an actual device state of the resource limited device;
means for distributing a state variable change notification being based on the change notification message within the networked control system according to a requirement of a control application of the networked control system.

13. The proxy device according to claim 12, comprising a storage for storing values of state variables belonging to the resource limited device and wherein the proxy device is configured to replace a stored state variable value by a corresponding actual state variable value received with the change notification message.

14. The proxy device according to claim 12, comprising passive coupling technology means for powering the resource limited device in order to retrieve the change notification message.

15. The proxy device according to claim 12, being configured to transmit an acknowledgement broadcast after having received the change notification message.

16-30. (canceled)
